(19) United States
(12) Patent Application Publication
(10) Pub. No.: US 2015/0113875 A1
(43) Pub. Date: Apr. 30, 2015

(54) Apparatus and Method for Optimizing Delivery of Nutrients in a Hydroponics System

(71) Applicant: Matthew Liotta, Atlanta, GA (US)

(72) Inventor: Matthew Liotta, Atlanta, GA (US)

(21) Appl. No.: 14/365,514

(22) PCT Filed: Mar. 29, 2012
(86) PCT No.: PCT/US2012/031119

§ 371 Date: Jun. 13, 2014

Related U.S. Application Data
(60) Provisional application No. 61/569,901, filed on Dec. 13, 2011.

(51) Int. Cl. A01G 31/02; A01G 31/00

(52) U.S. Cl. CPC A01G 31/02; A01G 31/00
USPC 47/62 R; 47/59 R

(57) ABSTRACT

A method and apparatus for improving nutrient delivery to plants in a hydroponics system is disclosed. A farming assembly in accordance with the various embodiments of the present invention include a frame (18), a flume (12), and an adjuster (16). The frame is configured to hold a plurality of plants (14) in plant receiving positions above a flume, wherein the flume contains a liquid such as a water and nutrient solution. The adjuster controls the distance between the plurality of plants in the frame and the liquid in the flume by either raising the frame with respect to the flume, lowering the flume with respect to the frame, or utilizing a gate (36) as a dam within the flume. Thus, the various embodiments of the present invention adjust the ratio of roots (19) exposed to air or immersed in liquid. By controlling the distance between the liquid and the roots of the plants, the present invention allows the plants to receive exposure to the air for a certain amount of time (such as thirty minutes), and then, become immersed in the liquid for a certain amount of time, which has the effect of increasing nutrient delivery to the plants and increasing plant growth speed.

### TECHNOLOGICAL FIELD

Embodiments of the present invention relate generally to farming techniques and, more particularly, to a method and apparatus optimizing delivery in a hydroponics system.

### BACKGROUND

For many years, agriculturalists, horticulturalists, botanists, and farmers have known that certain types of food-producing plants tend to grow better, faster, and be more fruitful in certain areas of the world. The reasons are numerous, including differences in soil, growing seasons, temperatures, and rainfall amounts in different areas coupled with differences in the genetic makeup of different plants.

This difficulty in growing certain types of food-producing plants in certain areas has led grocers, markets, and restaurants in such areas to obtain fruits and vegetables provided by such food-producing plants from other areas of the world in which such food-producing plants grow best. The fruits and vegetables are, generally, transported by airplane, ship, rail, truck, and/or combination thereof to the grocers, markets, and restaurants. In the past, the cost of transporting the fruits and vegetables was relatively inexpensive. However, with the general trend in fuel prices increasing, the cost of transporting the fruits and vegetables has trended upward as well, thereby making the transportation of the fruits and vegetables less attractive and the purchase prices of such fruits and vegetables higher.

There is, therefore, a need in the industry for apparatuses and methods that enable the growing of food-producing plants in the local areas in which the fruits and vegetables provided by such plants are sold and/or consumed, that minimizes the costs of transporting such fruits and vegetables, and that resolves these and other problems, difficulties, and shortcomings of present apparatuses and methods.

### BRIEF SUMMARY

Therefore, to address the needs and deficiencies described above, methods and apparatus are provided according to the example embodiments for providing for the efficient delivery of nutrients to plants in a hydroponics system.

One embodiment provides a method for growing plants, comprising the steps of: positioning a plurality of plants having roots in a frame, such as and without limitation a polyvinyl chloride (PVC) pipe, substantially above a flume with the roots depending from the frame; causing a liquid such as a water and nutrient solution to flow within the flume, the liquid having a surface defining a distance relative to the frame; and adjusting the distance between the frame and the surface of the liquid. The step of adjusting may comprise moving the flume closer to the frame while maintaining the frame in a stationary position, moving the frame closer to the flume while maintaining the flume in a stationary position, actuating a stopper coupled to the flume or frame, or utilizing a computer device configured to actuate a stopper during certain time intervals, such as without limitation, thirty (30) minutes. The roots of the plurality of plants may be contained within a basket, wherein the basket is suspended within the interior of the flume and/or frame. This basket may be constructed of any material that would permit the roots of the plants to obtain nutrients from the liquid, such as a wire basket or mesh basket.

Another embodiment provides an apparatus comprising a frame configured to hold a plurality of plants having roots depending therefrom; a flume positioned substantially beneath said frame, said flume having a first end and a second end distance from said first end, said flume being adapted for the flow of liquid therein between said first end and said second end, and an adjuster for changing the distance between the surface of the liquid and said frame. The frame further comprises a plurality of plant receiving positions for receiving a plurality of plants.

The adjuster comprises a computer system and an actuator, wherein said computer system is configured to transmit signals to the actuator to cause the actuator to control a gate, for example, to rotate the gate about a longitudinal axis with respect to the frame. The computer system may be configured to transmit signals to cause the actuator to rotate a gate at 30 and 90 degree angles with respect to the frame.

The present invention provides a number of ways in which the adjuster can control the distance between the liquid and the plurality of plants. For example, the adjuster may be coupled to the frame, and is configured to raise and lower the frame with respect to the flume. The adjuster may be coupled to the flume, and is configured to raise and lower the flume with respect to the frame. Alternatively, the adjuster may comprise a damming device positioned in the interior of the flume to control the passage of water past the damming device.

The various embodiments of the present invention also comprise methods, apparatus, and means for adjusting the ratio of roots exposed to air or immersed in liquid. While only turning on and off the liquid in the flume, the present invention may result in either 100% of the roots being exposed to air, or 100% of the roots exposed to a nutrient solution such as water. However, the various embodiments of the present invention provide for a more tailored nutrient delivery system, as the system may target a specific percentage of roots to be exposed to air, or the nutrient solution, at any given time. For example, the various embodiments of the present invention could be configured to expose 10% of the roots to air for thirty (30) minutes and, then 90% of the roots exposed for thirty (30) minutes. In fact, any permutation can be programmed in the computer system to optimize the growth of the plant. The prior art does not provide for such a custom delivery method, and thus, the present invention provides for a more optimal solution for plant growth optimization.

### BRIEF DESCRIPTION OF THE SEVERAL VIEWS OF THE DRAWINGS

Having thus described embodiments of the invention in general terms, reference will now be made to the accompanying drawings, which are not necessarily drawn to scale, and wherein:

FIGS. 1-2 illustrate a farming system according to an embodiment of the present invention.

FIG. 3A provides a cross-sectional view of a farming system according to an embodiment of the present invention with the roots immersed in nutrient solution.

FIG. 3B is a cross-sectional view of a farming system in accordance with yet another embodiment of the present invention wherein the roots are exposed to air.

FIG. 4 is a cross-sectional view of a farming system in accordance with yet another embodiment of the present invention.

FIG. 5 is a block diagram illustrating the components of the farming system according to an embodiment of the present invention.

FIG. 6 is block diagram illustrating an adjuster in accordance with one embodiment of the present invention.

FIG. 7 is a flow diagram illustrating the steps of a method in accordance with an embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

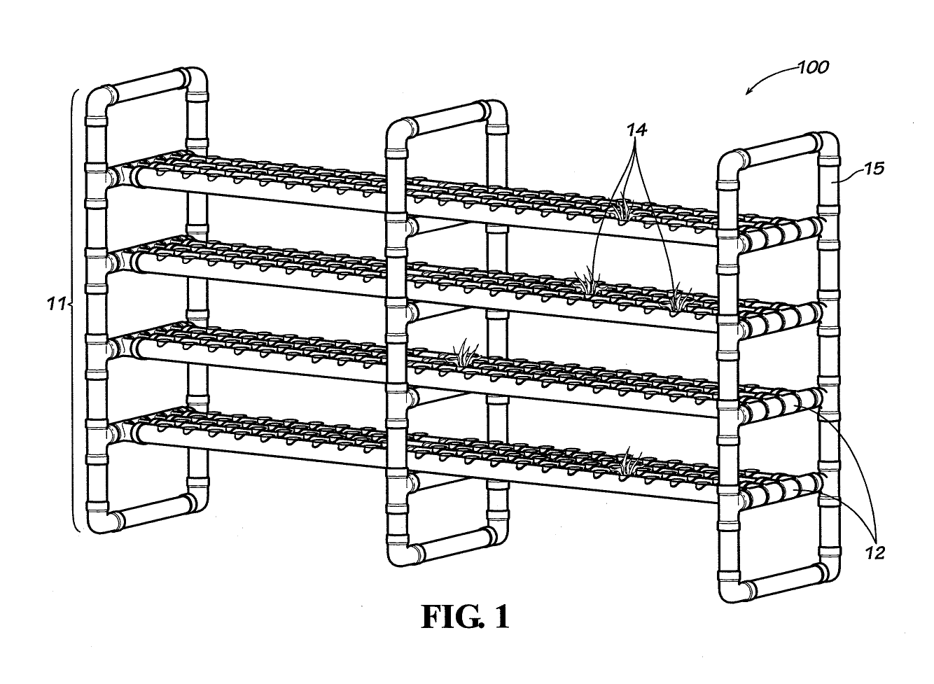

In accordance with an example embodiment of the present invention shown in FIGS. 1-2, farming assembly 100 comprises flume rack assembly 11, which comprises a plurality of flumes 12 and a plurality of main flume channels 15, wherein the flumes extend along a horizontal axis with respect to the main flume channels. The plurality of flumes 12 are configured for holding a plurality of plants 14, and are coupled to a main flume channel 15 on at least one end. Those skilled in the art will recognize that a main flume channel 15 is utilized in a larger farming assembly embodiment, and thus, in a smaller environment, the farming assembly may only comprise a single flume 12.

Each flume 12 may comprise any suitable mechanism, device, or structure for holding a plurality of plants. For example and without limitation, flume 12 may comprise a PVC pipe structure or a plastic tray. Flume 12 may also be a device capable of holding any type of liquid, such as water and nutrient solution. Those skilled in the art will recognize that each flume 12 may comprise any number of devices within the spirit and scope of the present invention.

Each flume 12 may comprise a plurality of plant receivers 16 for holding a plurality of plants 14. The plant may be secured within its respective plant receiving position via a frame 18, such as a wire or mesh basket, which is coupled to the plant receiving position. Each frame 18 is configured to receive a plant whereby the roots depend therefrom, and fall into the flume 12 interior, and the top portion of the plant remains above the profile of the flume 12.

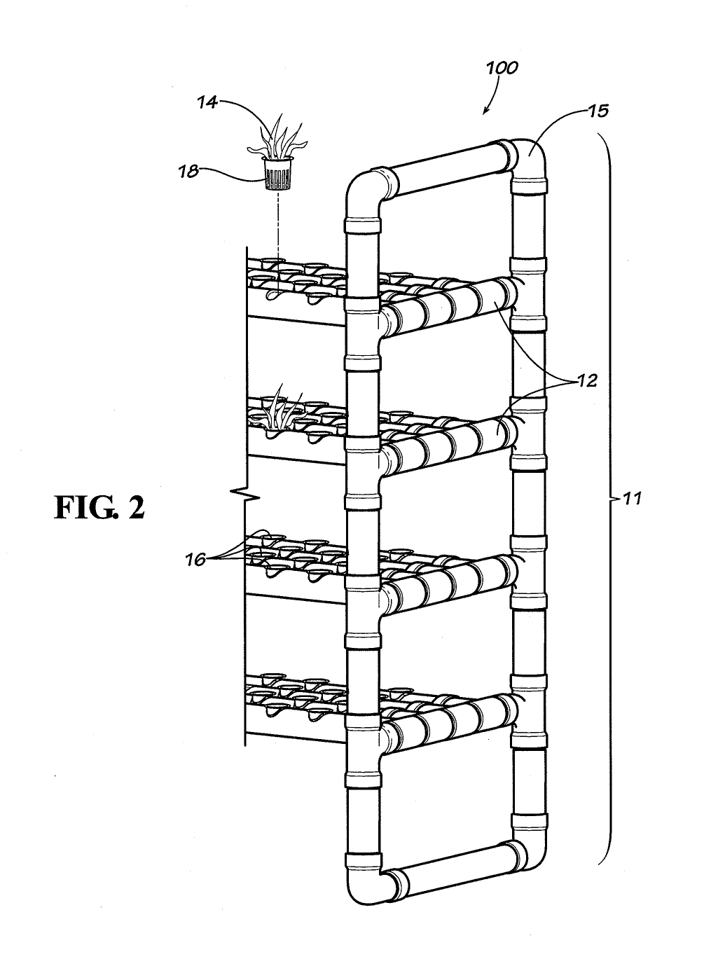

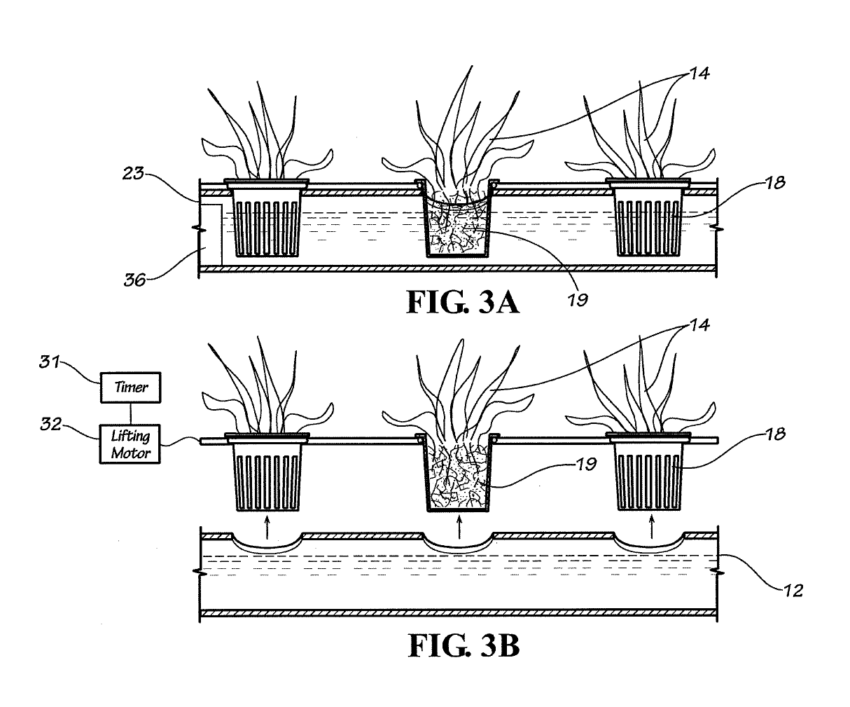

FIG. 3A provides a cross-sectional view of a farming system according to an embodiment of the present invention with the roots 19 immersed in water or nutrient solution. As shown in FIG. 3A, the water or nutrient solution is configured to reach a predetermined level 23. Those skilled in the art will recognize that any predetermined level may be utilized in order to expose a desired percentage of the roots 19 of plants 14 to the water or nutrient solution.

In the embodiment shown in FIG. 3B, a timer 31 and a lifting motor 32 are utilized as the adjuster mechanism to lift the plants 14 out of the water or nutrient solution to expose roots 19 to air. At a predetermined time the lifting motor 32 receives a signal from the timer 31, and in response, lifts the frames 18 out of the flume 12, thereby exposing the roots 19 of the plants 14 to air. Those skilled in the art will recognize that, in addition to a timer and lifting motor, any number of other mechanisms may be utilized to control the height of the water within the flume 12.

For example, and without limitation, each flume may comprise a gate 36, referring again to FIG. 3A, which is positioned opposite a first end. The gate 36 may comprise any number of structures, including without limitation a damming device configured to conform to the interior profile of the flume to prevent the passage of liquid. The gate 36 is positioned in such a manner as to permit liquid to pass, and hence, lower the level of the liquid within the flume. When the water level is lowered, the roots of the plurality of plants are exposed to air. The damming device may rise to prevent the passage of liquid past the gate. The gate 36 may rise in response to a signal from adjuster, for example, upon a certain amount of time passing. For example and without limitation, this amount of time may comprise thirty (30) minutes. Once the gate 36 has risen to a certain level, the level of the liquid within the flume is higher, and thus, the roots of the plurality of plants are immersed within the liquid.

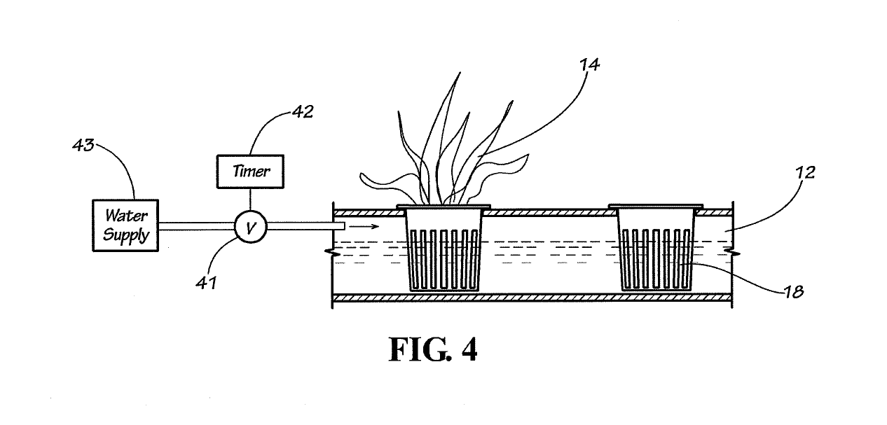

FIG. 4 is a cross sectional view of a farming system in accordance with yet another embodiment of the present invention. In this embodiment of the invention, a valve 41 is utilized to control the flow and height of the water within the flume 12. This valve 41 may comprise any number of commercial or custom valves. For example, the valve 41 may comprise any value with uniform flow interior diameters, or a valve wherein the flow is controlled by narrowing the interior diameter of either the entrance to the particular flume comprising the plants from the main flume channel. Those skilled in the art will recognize that any number of valve configurations may be used within the spirit and scope of the present invention. In yet another embodiment, a timer 42 may be communicatively coupled to the valve 41 to control the diameter of the valve 41 at different times, therefore controlling the valve 41 to deliver nutrient solution or water from water supply 43 to the plants 14 at predetermined times during programmed time intervals.

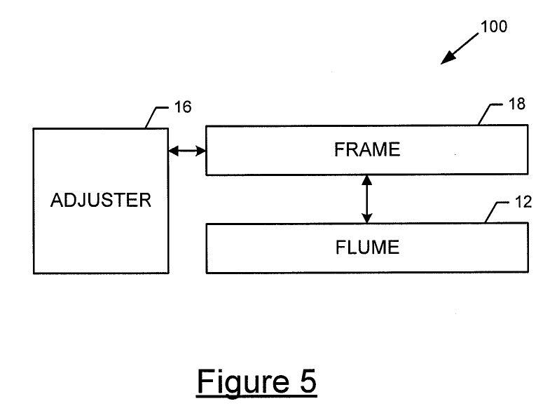

FIG. 5 is a block diagram illustrating the components of the farming system according to an embodiment of the present invention. Adjuster 16 may be coupled to only frame 18, as shown in FIG. 5. In other embodiments, adjuster 16 may be coupled to only flume 12, or in yet other embodiments, adjuster 16 may be coupled to both flume 12 and frame 18. These couplings between the adjuster and the other components of the farming system will depend on which embodiment is utilized. For example, if an embodiment of the present invention is utilized that provides the frame 18 will be raised and lowered with respect to the flume 12 to control the distance between the liquid and the roots of plants contained within the frame 18, then the adjuster will be coupled to the frame 18, and optionally, coupled to the frame 18 and flume 12.

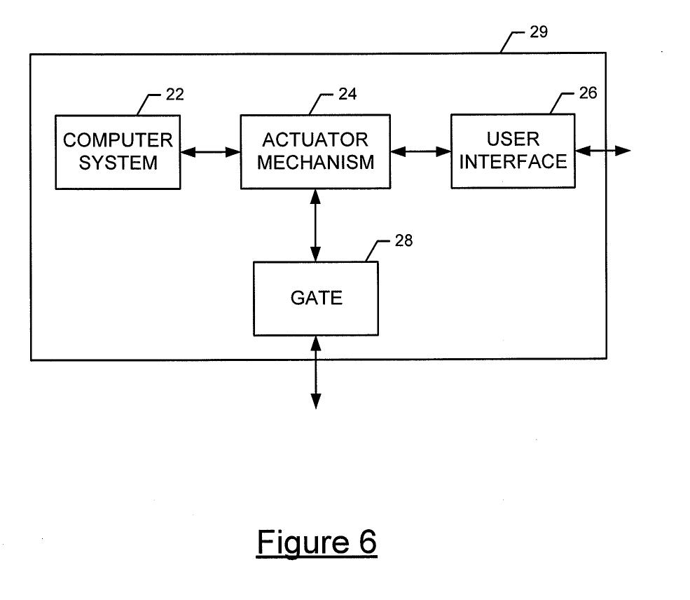

FIG. 6 is block diagram of an adjuster in accordance with one embodiment of the present invention. The adjuster, in the various embodiments of the present invention, may comprise any mechanism or device configured to increase and decrease the distance between the frame and the surface level of the liquid in the flume. In one embodiment, the adjuster may comprise a timer used in conjunction with a gate (or dam) device. In another embodiment, a valve device wherein the value is configured to have varying interior diameters for controlling the flow of water in the flume 12.

In this embodiment shown in FIG. 6, the adjuster 29 may comprise a computer system 22 and an actuator mechanism 24 which may be controlled by computer system 22. A gate 28, which may be controlled by actuator mechanism 24, is positioned in the farming system 100 as to increase and decrease the distance between the frame and the surface level of the liquid in the flume. For example and without limitation, the gate 28 may be located at a second end of the flume to control the amount the amount of water to exit the flume (and hence control the amount of water retained within the flume).

As mentioned above, the actuator mechanism 24 is operably connected between the computer system 22 and the gate 28. The profile and shape of gate 28 may match or substantially match a cross section of flume in such a manner in which gate may block the ingress and egress of water within the flume. In this embodiment, the gate 28 may be pivotally connected to the flume to allow more or less water to flow or exit the flume, or in another embodiment, gate 28 could translate in a vertical direction relative to the flume to control the flow of liquid.

The actuator mechanism 24 may comprise any number of mechanical means for rotating, lifting, or dropping a gate, and may, or may not be, coupled to a computer device. For example and without limitation, such an actuator mechanism may include a lever arm or an electric lifting motor configured to cause gate 28 to pivot 90 or 30 degrees. The electric lifting motor may, without limitation, work in conjunction with a timer, as shown in FIG. 3B. Actuator mechanism may also comprise a motor for rotating a shaft that extends through the flume 12 in such a manner that when the motor turns the shaft 30 degrees, the gate 28 turns 30 degrees about the longitudinal axis of the shaft, thereby allowing more or less liquid to exit the flume 12, as a result. Computer system 22 may send signals to actuator mechanism 24 to instruct certain actions to occur. For example, computer system 22 may, upon a certain amount of time elapsing, instruct the actuator mechanism to lower the position of the gate 28 to allow water to flow past the gate, and hence, lower the water level. The gate 28 may be lowered, or raised, by any mechanical means including a motor or linkage system.

Gate 28 may be located on either end of the farming assembly 100. Those skilled in the art will recognize that gate 28 may be positioned any number of ways with respect to the flume 12 in order to control the amount and level of water within the flume 12, and also, control the height of the water.

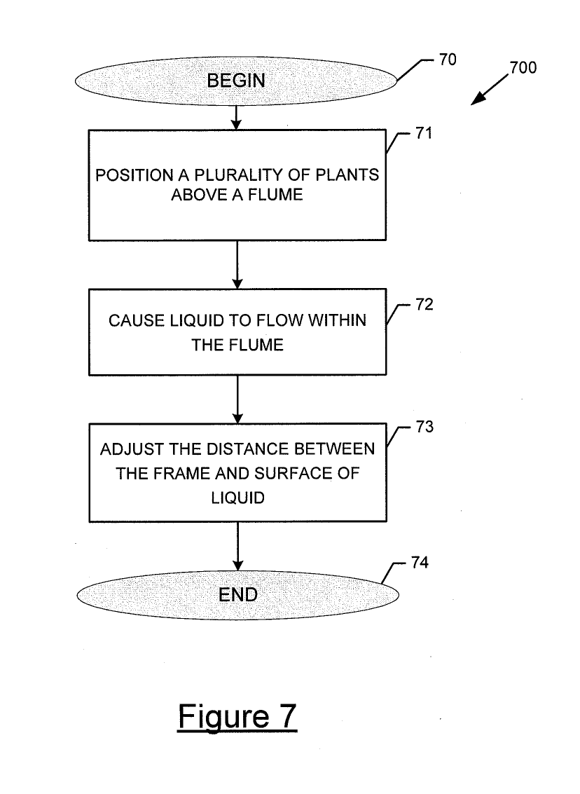

While example embodiments of the present invention have been described above in conjunction with FIGS. 1-6, a flowchart of the operations performed from the perspective of a user is now provided with reference to FIG. 7. It will be understood that each block of the flowcharts, and combinations of blocks in the flowcharts, may be implemented by a user comprising various means, such as hardware, firmware, processor, circuitry, and/or other device associated with execution of software including one or more computer program instructions. For example, one or more of the procedures shown by the flowcharts may be embodied by computer program instructions. In this regard, the computer program instructions which embody the procedures depicted by the flowcharts may be stored by a memory device of an apparatus employing an embodiment of the present invention and executed by a processor in the apparatus.

As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special-purpose hardware-based computer systems which perform the specified functions, or combinations of special purpose hardware and computer instructions.

FIG. 7 illustrates the steps taken by any type of user, wherein user not only includes a human user, but also, any type of computer, computer-implemented process, or the like, in operating the system of the present invention. As shown in FIG. 7, method 700 begins at step 70, and proceeds to the step of positioning a plurality of plants having roots in a frame substantially above a flume, wherein the roots depend from the frame. Each frame may comprise any mechanism or structure capable of holding a plant and roots of plant, for example and without limitation, a basket made of wire, mesh, or any other type of material which may permit the ingress of water to the roots of the plant.

Method 700 then proceeds to step 72, which causes a liquid to flow within the flume, wherein the liquid has a surface which defines a distance relative to the frame.

Once liquid is flowing within the flume, method 700 comprises adjusting the distance between the frame and the surface area of the liquid in step 73. This step may involve any number of methods or structures, including an adjuster, such as a timer used in conjunction with a lifting motor, a variable drive pump, or a gate or damming device placed within the flume. In the embodiment utilizing a variable drive pump, at any given time, the variable drive pump may adjust its speed, and therefore flow output, to compensate for the current status of the valves. Thus, more values are open to create more flow, and vice versa. Method 700 terminates at step 74.

The various example embodiments of the present invention are beneficial for a number of reasons. For example, by adjusting the distance between the frame and the flume, the present invention exposes plants positioned in the frame to air for a period of time, and nutrient solution for a period of time, in such a manner that results in increased nutrient delivery to the plants and hence expedited plant growth. By improving nutrient delivery and increasing the speed of plant growth, the present invention allows farmers to address consumer demand more quickly, and also, realize higher revenue.

Additionally, there are other benefits provided by the various embodiments of the present invention over the prior art. In hydroponics techniques, the nutrient film technique (NFT) uses a continuous flow of liquid, which means in part that the pump requirements of NFT are a function of the aggregate amount of flow across the given channels. In the various embodiments of the present invention, the height of the water is directly proportional to the amount of flow across the channel. As such, like NFT, the pump requirement is a function of the aggregate amount of flow across the channels. However, unlike NFT where each channel has an equal flow, the various embodiments of the present invention provide variability in the flow: higher water results in increased flow. For example, in one embodiment wherein the height is staggered symmetrically across the entire system, one channel has a low height while another channel has a high height. The net effect of this staggered height in the system is a reduction in both the peak flow and average requirements placed on the pump, which results in a lower average flow requirement when compared with NFT. Therefore, the various embodiments of the present invention provide for a smaller more energy efficient pumping setup.

The second additional benefit of the various embodiments of the present invention over NFT is related to the effect of water flow in the case of a pump failure or power outage. With NFT, the plants will begin to die within hours if there is not any flow in the system. Because the various embodiments of the present invention utilize a dam to set the minimum height of the water, if there is no flow in the system, a certain amount of the water remains in the pipe. If this water is not replaced, the nutrient content will decline, and therefore will slow the growth of plants. However, the plants will not die as in prior art systems. Therefore, the various embodiments of the present invention comprise, effectively, a built-in disaster recovery mechanism.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for growing plants, comprising the steps of:
positioning a plurality of plants having roots in a frame substantially above a flume with the roots depending from the frame;
causing a liquid to flow within the flume, the liquid having a surface defining a distance relative to the frame; and
adjusting the distance between the frame and the surface of the liquid.

2. The method of claim 1, wherein adjusting comprises moving the flume closer to the frame while maintaining the frame in a stationary position.

3. The method of claim 1, wherein adjusting comprises moving the frame closer to the flume while maintaining the flume in a stationary position.

4. The method of claim 1, wherein adjusting comprises an adjuster actuating a stopper coupled to the flume or frame.

5. The method of claim 4, wherein said adjuster comprises a computer device configured to actuate a stopper during certain time intervals.

6. The method of claim 5, wherein said certain time intervals may comprise thirty (30) minute time intervals.

7. The method of claim 1, wherein the frame comprises a polyvinyl chloride (PVC) pipe.

8. The method of claim 1, wherein said liquid comprises a water and nutrient solution.

9. The method of claim 1, wherein said roots are enclosed within a basket.

10. The method of claim 9, wherein said basket comprises a wire mesh basket.

11. The method of claim 1, wherein the step of adjusting comprises utilizing a valve to control the flow of water to the frame.

12. An apparatus comprising:
a frame configured to hold a plurality of plants having roots depending therefrom;
a flume positioned substantially beneath said frame, said flume having a first end and a second end distance from said first end, said flume being adapted for the flow of liquid therein between said first end and said second end, and
an adjuster for changing the distance between the surface of the liquid and said frame.

13. The apparatus of claim 12, wherein said frame further comprises a plurality of plant receiving positions for receiving a plurality of plants.

14. The apparatus of claim 12, wherein the adjuster comprises a computer system and an actuator, wherein said computer system is configured to transmit signals to the actuator to cause the actuator to control a gate.

15. The apparatus of claim 14, wherein the computer system is configured to transmit signals to cause the actuator to rotate a gate about a longitudinal axis with respect to the frame.

16. The apparatus of claim 15, wherein the computer system is configured to transmit signals to cause the actuator to rotate a gate at 30 and 90 degree angles with respect to the frame.

17. The apparatus of claim 16, wherein the adjuster is coupled to the frame, and is configured to raise and lower the frame with respect to the flume.

18. The apparatus of claim 12, wherein the adjuster is coupled to the frame, and is configured to raise and lower the flume with respect to the frame.

19. The apparatus of claim 12, wherein the adjuster comprises a damming device positioned in the interior of the flume to control the passage of water past the damming device.
